(19) United States
(12) Patent Application Publication
(10) Pub. No.: US 2021/0365629 A1
(43) Pub. Date: Nov. 25, 2021

(54) ONLINE REAL-TIME INTERACTIVE COLLABORATIVE DOCUMENT SYSTEM

(71) Applicant: MARKADOC CORPORATION, Rochester, NY (US)

(72) Inventors: Shawn Jamison Mott, Rochester, NY (US); Timothy A. Bissell, Hamlin, NY (US); Pete Meagher, Rochester, NY (US); Cory Janik, Rochester, NY (US); Michael Clark, Rochester, NY (US); Yanika Telus, Rochester, NY (US); Colleen Simons, Rochester, NY (US); Josh Simson, Rochester, NY (US); Tilo Schrodt, Rochester, NY (US); Christopher Coon, Rochester, NY (US)

(21) Appl. No.: 17/325,100

(22) Filed: May 19, 2021

Related U.S. Application Data
(60) Provisional application No. 63/027,012, filed on May 19, 2020.

(51) Int. Cl. G06F 40/169; H04L 29/06; G06F 16/93

(52) U.S. Cl. CPC G06F 40/169; G06F 3/0486; G06F 16/93; H04L 65/403

(57) ABSTRACT

A system and method for facilitating annotation of a digital document between first and second computing devices is provided. The system comprises a database/server that receives the digital document from the first computing device and communicates the digital document to the second computing device. The second computing device receives and displays the digital document for annotation. The annotation produces an annotated digital document which includes the original document data and annotated document data overlaying the original document without modification to the original document data.

### CROSS-REFERENCE TO RELATED APPLICATIONS

This application claims the benefit of U.S. Patent Application No. 63/027,012, filed May 19, 2020, and entitled Online Real-Time Interactive Collaborative Document System, the entirety of which is hereby incorporated by reference.

### FIELD OF THE INVENTION

The present invention relates to a system which permits online collaborative document sharing on any web-enabled device, and more particularly to a system which permits multiple users to annotate a document in real-time without modifying the underlying original draft document.

### BACKGROUND OF THE INVENTION

The traditional redline process which applies to many industries is that paper copies of a document are distributed to one or more people for review, comment and possible editing. In the field of controls engineering, panel drawings are printed out on paper and a technician will then use those prints to build the actual panel. During the build process, the technician may find mistakes within the current prints. The corrections for these mistakes are noted in red pen on the physical piece of paper. Once the panel is built, the technician delivers the redline drawings back to the design engineer so that the design engineer may update the drawings with the corrections included. Similar processes exist in the construction, real estate, legal, educational and other markets. Such redline processes are time-consuming and prone to errors.

Thus, there is a need for a web enabled application that allows for real-time document collaboration on any web enabled device.

### SUMMARY OF THE INVENTION

The present invention provides, in a first aspect, a system comprising a software program operable to allow annotation of a document which is accessed on a computer or other web-enabled device such as a smart phone, tablet or personal computer (PC), for example. Multiple parties may simultaneously access the document and provide annotations in real-time.

The program allows users to annotate any document which has been uploaded to a web location only accessible by designated individuals (“permitted users” accessing the document using appropriate security protocols such as passwords, for example). The annotations may include notes and questions to other permitted users, for example. In a preferred embodiment, the annotations are easily added to the displayed document using a “drag and drop” function. The notes are listed in a log appearing in a column to the side of the document such that all permitted users can view any of the posted notes by clicking on the desired note log. Permitted users can add to any log note or question as desired.

Additional objects, advantages and novel aspects of the present invention will be set forth in part in the description which follows, and will in part become apparent to those in the practice of the invention, when considered with the attached figures.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1 is a screen shot showing an example of a document under real time collaboration by two permitted users;

FIG. 2 is a schematic drawing showing an exemplary system that may be used to implement any of the methods or processing described herein in accordance with one aspect of the present invention;

FIG. 3A is an exemplary screen shot of a user interface welcoming screen;

FIG. 3B is an exemplary screen shot of a user interface Get Started screen;

FIG. 4 is an exemplary screen shot of a user interface dashboard screen;

FIG. 5 is an exemplary screen shot of a user interface User Profile screen;

FIG. 6A is an exemplary screen shot of a user interface “Groups” screen; and

FIG. 6B is an exemplary screen shot of a user interface “Groups” screen showing group members.

### DETAILED DESCRIPTION OF A PREFERRED EMBODIMENT

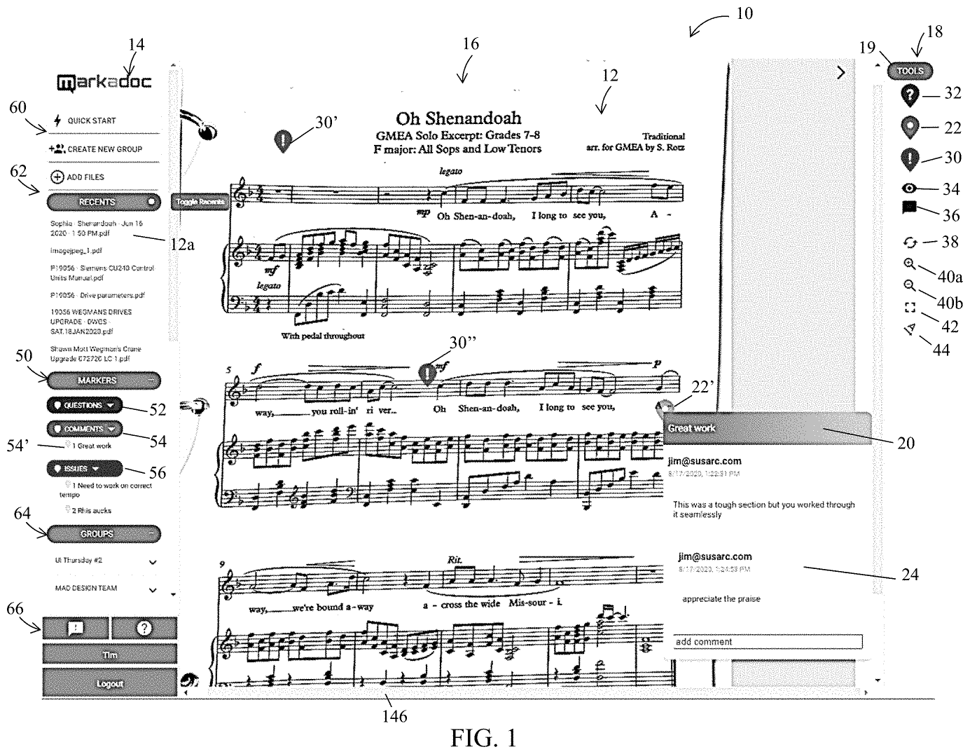

Referring to FIG. 1, the present invention provides an on-line document collaboration system 10 operable to display a document 12 for group collaboration by permitted users who have been granted secure access to the secure internet site where system 10 is located.

System 10 comprises a computer program which allows annotation of any commonly shared document such as document 12 which in this example is a digital copy of sheet music for the song “Oh Shenandoah”. Any desired file type may be used (e.g., PDF, jpg, jpeg, tiff, etc.). System 10 presents a user interface comprised of three columns, 14, 16, 18. Left-hand column 14 may be referred to as a “Navigation” column, while center column 16 is for document 12 display and right-hand column 18 contains “action items”, all of which will be described in greater detail below. In the example provided in FIG. 1, the document is in pdf file format as seen at reference numeral 12a in left-hand Navigation column 14.

The system 10 allows annotation of the document 12 easily and without requiring any electronic drawing features in the computer application. The application instead uses “drag-and-drop” functionality to create virtual “sticky notes” on the displayed document 12, such as via action items or “Tools” 19 from right-hand column 18. In the example provided in FIG. 1, a “Comment” 20 was created by selecting comment action item 22 from Tools 19, such as a tear-drop shaped flag containing a period “.” from right-hand column 18 and dragging (mouse click and hold) the flag to a desired location within document 12 and “dropping” (release mouse click) the flag 22′. A text window 24 then opens immediately adjacent flag 22′ so that the user providing the comment can add text therein. Text window 24 overlays document 12 and in no way modifies the underlying digital file of document 12. Users may then optionally save or print document 12 with all or some of annotations displayed on the documents, as desired.

Other users may click “Comment” flag 22′ so as to open action window 24 to view the comment and add additional comments, if desired, in real-time. In one aspect of the invention, the location of the “Comment” flag 22′ is specifically selected by the original commenter whereby all users will understand that the comment made was directed toward the material located immediately adjacent to the flag. In another aspect of the present invention, the term “real-time” means having no more than 3-5 second delay between any addition and its subsequent display on each user's computing device, and more preferably to being nearly instantaneous (less than 1 second).

Users may also identify any specific issues that they have with specific portions of document 12. For instance, as shown in FIG. 1, an “Issue” may be created by selecting issue action button 30 from Tools 19, such as a tear-drop shaped flag containing an exclamation point “!” from right-hand column 18. Again, an “Issue” may be located on document 12 via drag-and-drop using a mouse, touchpad or other input device. As shown in FIG. 1, a first issue flag 30′ has been located near the top of document 12, while a second issue flag 30″ is located near the center of center column 16. A user selecting either issue flag 30′, 30″ will open a respective text window similar to text window 24 described above. The action window will present the text associated with the issue, as well as provide a text bar for further discussion amongst the users.

Additional functionalities offered by Tools 19 may include, but are not limited to, a “Question” flag 32, such as a tear-drop shaped flag containing a question mark “?” configured for drag-and-drop functionality similar to comment and issue flags 22, 30; a “Toggle markers” icon 34 which allows users to selectively view or hide all flags 22, 30, 32 on display 12; a “Toggle text” icon 36 which allows users to selectively view of hide text windows 24 on display 12; a “Refresh” icon 38 which allows the user to reload document 12; “Zoom” icons 40a, 40b which allow a user to zoom in 40a or out 40b the image shown in center column 16; a “Full Screen” icon 42 allowing the user to display center column 16 without left-hand or right-hand columns 14, 18; and a “Rotate image” icon 44 which allows the user to rotate the image displayed in center column 16.

Each time a flag 22, 30, 32 is placed within the digital file displayed within center column 16, a quick link is added under the Markers tab 50 within left-hand Navigation column 14. In one aspect of the invention, Markers tab 50 may function as a drop-down list which is further delineated into respective Questions, Comments and Issues sub-tabs 52, 54, 56, with each sub-tab comprising its own drop-down list populated with a numbered link and abridged text corresponding to each respective flag 22, 30, 32. In this manner, a user may select one class of flags to review and locate a specific flag within the digital file by clicking on the desired hyperlink under the selected sub-tab 52, 54, 56.

By way of example and without limitation thereto, as shown in FIG. 1, Comments sub-tab 54 may include a numbered link 54′, such as “1 Great work”, which corresponds to Comments flag 22′ described above. A user may wish to review this comment. Clicking on the link 54′ will direct the user to the specific flag 22′, and thus the specific location within the digital file shown in center column 16, and open the appropriate text window 24. This allows for quick filtering and searching for particular annotations while also allowing other users to add additional comments to the flag, all in real-time.

The system 10 thus provides ability to drag-and-drop an annotation, add comments and save them on a document. As all such annotations are electronically “layered onto” the display of the document 12, the original document itself remains unchanged.

As will be described in greater detail below, left-hand Navigation column 14 provides additional quick link functionalities, such as but not limited to Group Creator 60, Document Navigator 62, Group Navigator 64, as well as User Services 66.

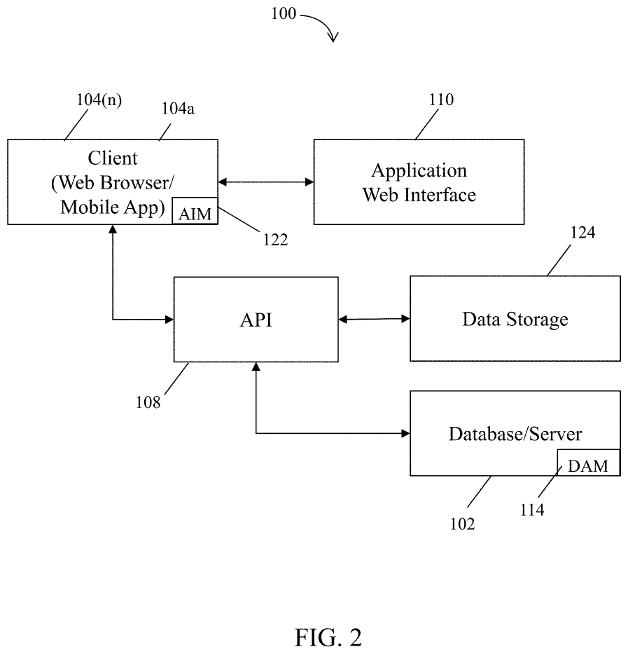

With reference to FIG. 2, the system, tools and methods described herein for facilitating annotation of a digital document may be implemented in hardware, software, and combinations thereof. Reference numeral 100 generally designates an exemplary network environment in which a computer-implemented document annotation system in accordance with one aspect of the invention may be implemented. System 100 utilizes one or more computing devices to facilitate the exchange of information between each computing device and a central database/server via an application programming interface (API) so as to enable real-time annotation of a shared digital document across the network. While the discussion herein refers specifically to a document annotation system, it should be understood that the system may be used in conjunction with other types of digital files, such as photographs, and/or editing functionalities.

For instance, system 100 may include a database/server 102 and any number of client computing devices 104(n) in communication with each other over a network via API 108. The network may be any type of network, such as a wide area network or local area network that allows for wired and/or wireless communication between database/server 102 client computing devices 104(n) and API 108. It should be understood that computing devices 104(n) may be a desktop computer, smartphone, tablet, or any other type of mobile computing device that includes a processor configured for implementing computer-executable instructions and methods as described herein. Computing devices 104(n) are web-enabled devices utilizing application web interface 110 as described in greater detail below.

In accordance with an aspect of the present invention, database/server 102 includes a processor and a memory having a document annotation module 114 stored therein. Document annotation module 114 includes a first set of computer-executable instructions configured for performing, through the use of the processor, a number of algorithmic steps that facilitate the document annotation process described herein. In particular, document annotation module 114 may be a cloud-based software platform that is accessible by computing devices 104(n) via application web interface 110.

First computing device 104a utilizes document annotation module 114 to, among other things, allow for the communication of an original digital document from first computing device 104a to a data store/memory 124 so that the original digital document can be annotated by annotator interface module 122 resident on each computing device 104(n). Annotator interface module 122 may include a set of computer-executable instructions stored in a memory of each computing device 104(n) and be configured for annotating the original digital document to produce an annotated digital document to be stored within data store/memory 124. The annotated digital document may then be communicated to each computing device 104(n) in real-time.

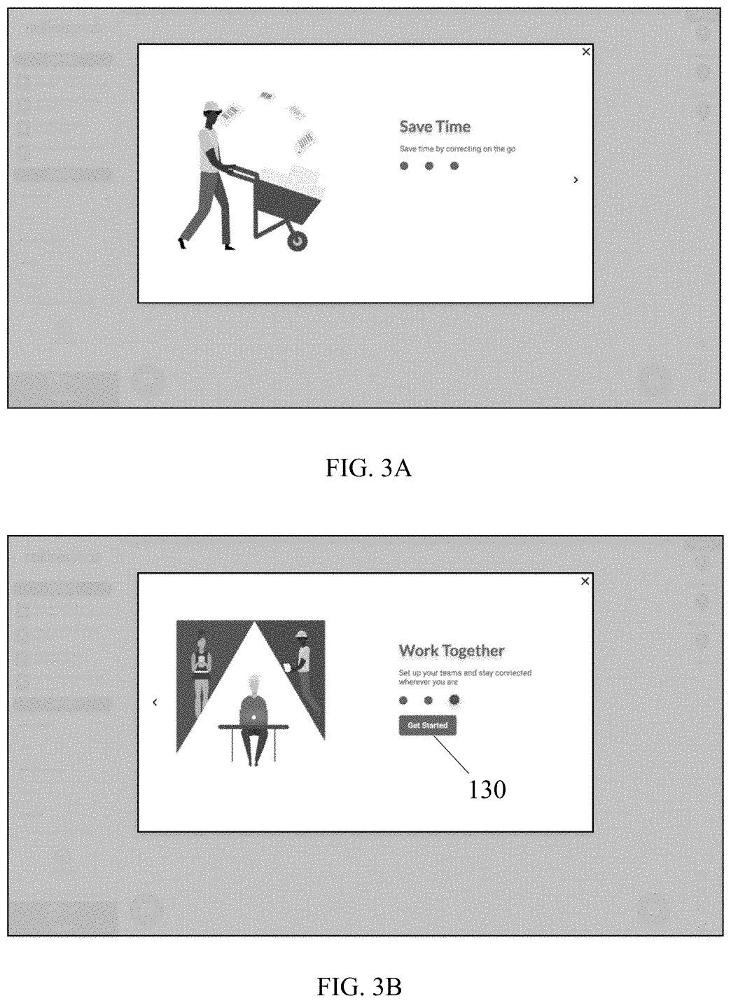

Annotator interface module 122 may be in the form of a software application (i.e., mobile app) or any other type of software program that can be easily downloaded and used to interact with computing devices 104(n). A series of exemplary screen shots are provided in FIGS. 3A-6B illustrating the functionality that may be provided by annotator interface module 122.

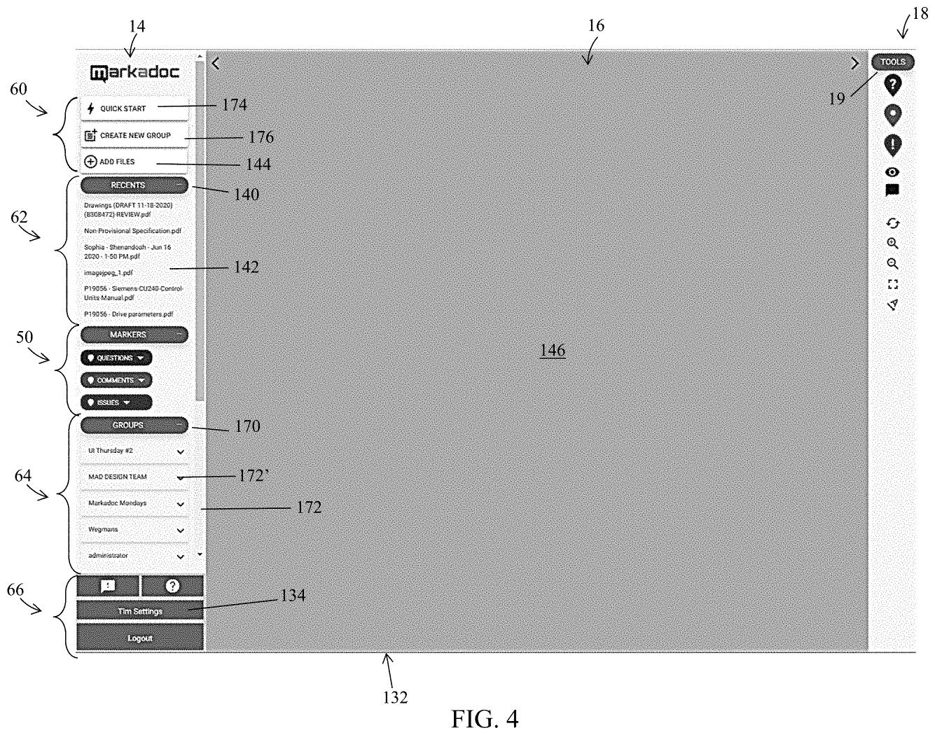

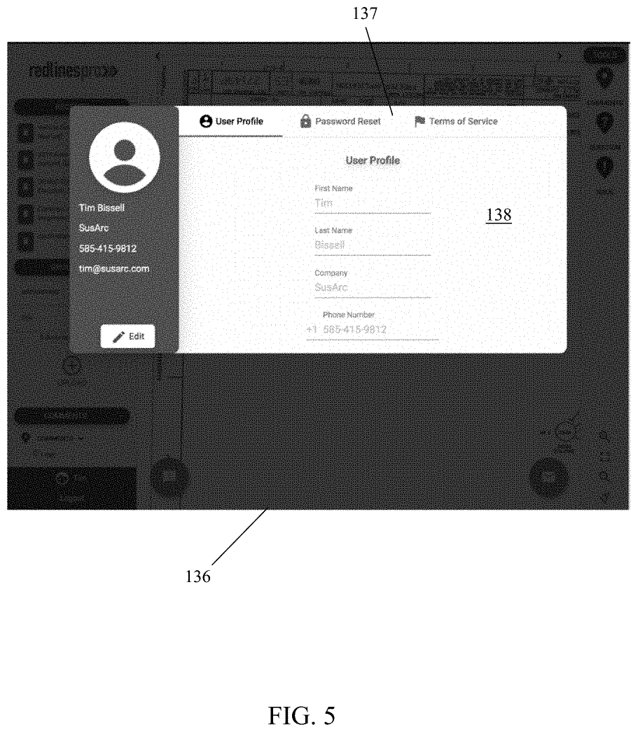

As seen in FIGS. 3A and 3B, annotator interface module 122 provides a welcome screen (FIG. 3A) as well as a start-up screen (FIG. 3B). Clicking, tapping or otherwise activating the “Get Started” action box 130 operates to open the dashboard 132 shown in FIG. 4. Dashboard 132 serves as the hub for additional interface functionalities. Clicking, tapping or otherwise activating a “User Account” or “Login” action box 134 within User Services 66 operates to open login interface 136 shown in FIG. 5. If a user is logging in for the first time, login interface will present type-in boxes whereby the user can create a username and password. The login interface 136 may then “remember” the user for future logins such that the user name and password need not be re-entered each time the user logs into dashboard 132. Rather, login interface 136 will overlay the User Profile Page 137 containing the User Profile 138 of the user currently logged into dashboard 132.

Returning to FIG. 4, with proper login credentials entered, a user may then access any authorized documents for annotation through Document Navigator 62. Document Navigator 62 may include a “Recents” tab 140 which presents a drop-down list 142 of recently view files. Should a different document be desired, the user may search for the document through the Group Navigator 64, described below. Once a document is selected, a current copy of the document 12, along with any annotations/flags 20, 30, 32, is displayed in document window 146 (center column 16) (see FIG. 1). A user may also upload a file to a group using the “Add files” link 144 within Group Creator 60, as will be described below.

In accordance with an aspect of the present invention, document management may further utilize Group Navigator 64 which includes a system of defined “Groups” 170 such that related documents can be grouped together in common folders 172 whereby only specified documents can be accessed and annotated by authorized members of the group. Only those groups for which a user has been granted access are displayed in Groups 170. Activating a specific folder 172′ presents a drop-down list of documents available for viewing and annotation.

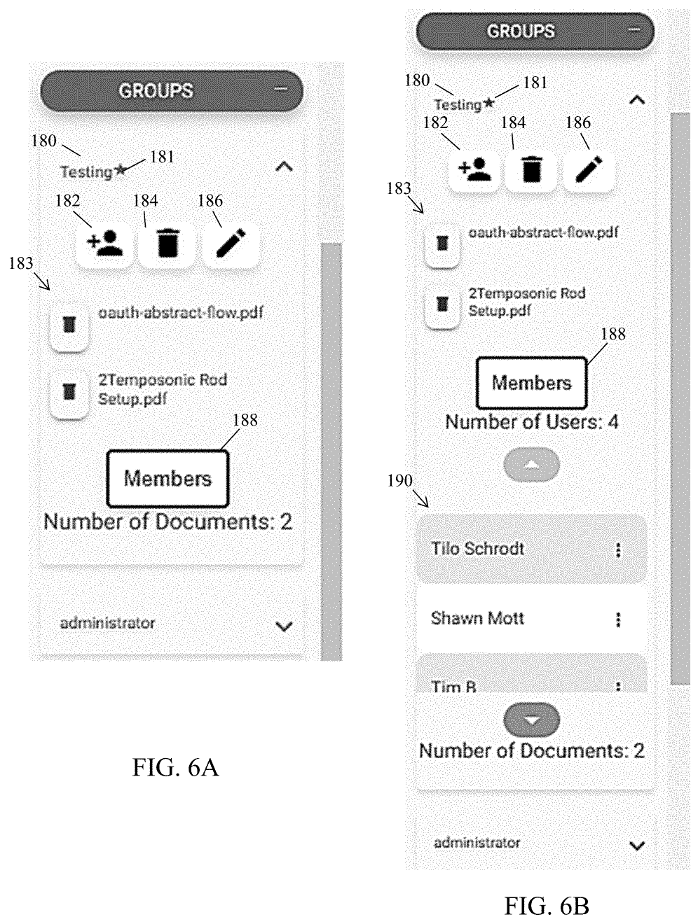

With continued reference to FIG. 4, group creation may be initiated using Group Creator 60 where a user may utilize “Quick Start” 174 to open a file having a pre-selected group member profile, or may initiate creation of a new group by clicking “Create New Group” 176 which will open a file with no pre-selected group members. With additional reference to FIGS. 6A and 6B, group creation and member allocations can be accessed by activating the Group Navigator 64 of dashboard 132 (FIG. 4). Activating Group Navigator 64 will present a drop-down list of all groups that the user has created or been granted access. Groups created by the user may be specially designated, such as via an asterisk, star or other indicia signifying that the creator also operates as the “administrator” of those groups.

As administrator, the user can open a pop-up window 178 such as that shown in FIG. 6A. As shown in FIG. 6A, the Group has been identified as “Testing” 180 and includes indicia 181 designated the user as administrator as well as a list of file(s) 183 added during creation of the group. A series of action boxes 182, 184, 186 and 188 become active. Action box 182 allows the administrator to add new, authorized members to the group. Action box 184 is used to delete the group while action box 186 allows the administrator to rename the group. As shown in FIG. 6B, activation of action box 188 labeled “Members” opens a drop-down list of all members 190 currently assigned to the group. Authorized members can then access the documents located within Group Navigator 64 for annotation, as described above.

From the foregoing, it will be seen that this invention is one well adapted to attain all the ends and objects hereinabove set forth together with other advantages which are obvious and which are inherent to the system and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A computer-implemented document collaboration system for facilitating annotation of a digital document between a first computing device and a second computing device, the system comprising:
a) a database/server including a memory and a processor, wherein the database/server is in communication with the first computing device and the second computing device over a network;
b) a first set of computer instructions that when executed by the processor of the database/server performs the steps of:
i) receiving the digital document from the first computing device over the network, wherein the digital document includes document data associated with the digital document, and
ii) communicating the digital document to the second computing device over the network, and
c) a second set of computer instructions configured for being stored in a respective memory of the first computing device and the second computing device, the second set of computer instructions configured for being executed by a respective processor of the first computing device and the second computing device to perform the steps of:
i) receiving the digital document from the database/server over the network,
ii) displaying the digital document on a respective display of the first computing device and the second computing device,
iii) allowing annotation of the digital document via a respective input device associated with the first computing device and the second computing device, wherein the annotation produces an annotated digital document which includes the original document data and annotated document data wherein the annotated document data overlays the original document without modification to the original document data,
iv) communicating the annotated digital document to the database/server over the network,
wherein the database/server receives the annotated digital document and makes the annotated digital document available to each of the first computing device and the second computing device.

2. A method programmed for execution in a computing environment for facilitating annotation of a digital document between a first computing device and a second computing device, wherein the first computing device and the second computing device are in communication with a database/server over a network, the database/server including a processor and a memory, the processor configured for executing computer instructions for performing the method comprising:
a) receiving the digital document from the first computing device over the network, wherein the digital document includes document data associated with the digital document;
b) communicating the digital document to the second computing device over the network;
c) displaying the digital document on a display of the second computing device;
d) allowing annotation of the digital document via an input device associated with the second computing device, wherein the annotation produces an annotated digital document which includes the original document data and annotated document data wherein the annotated document data overlays the original document without modification to the original document data;
e) communicating the annotated digital document to the database/server over the network; and
f) making the annotated digital document available to the first computing device over the network.

3. A non-transitory computer-readable storage medium having instructions stored thereon for execution by at least one processor for implementing a method facilitating annotation of a digital document between a first computing device and a second computing device, wherein the first computing device and the second computing device are in communication with a database/server over a network, the server including a processor and a memory, the method comprising:
a) receiving the digital document from the first computing device over the network, wherein the digital document includes document data associated with the digital document;
b) communicating the digital document to the second computing device over the network;
c) displaying the digital document on a display of the second computing device;
d) allowing annotation of the digital document via an input device associated with the second computing device, wherein the annotation produces an annotated digital document which includes the original document data and annotated document data wherein the annotated document data overlays the original document without modification to the original document data;
e) communicating the annotated digital document to the database/server over the network; and
f) making the annotated digital document available to the first computing device over the network.
